(19) United States
(12) Patent Application Publication
(10) Pub. No.: US 2020/0380725 A1
(43) Pub. Date: Dec. 3, 2020

(54) CALIBRATION FOR VEHICLE CAMERAS

(71) Applicant: GM GLOBAL TECHNOLOGY OPERATIONS LLC, Detroit, MI (US)

(72) Inventors: Brian J. Hufnagel, Brighton, MI (US); Hao Yu, Troy, MI (US); Wende Zhang, Birmingham, MI (US)

(73) Assignee: GM GLOBAL TECHNOLOGY OPERATIONS LLC, Detroit, MI (US)

(21) Appl. No.: 16/423,821

(22) Filed: May 28, 2019

(51) Int. Cl. G06T 7/80; H04N 17/00

(52) U.S. Cl. CPC G06T 7/80; G06T 2207/30252; H04N 17/002

(57) ABSTRACT

In various embodiments, methods and systems are provided for calibrating vehicle cameras. In certain embodiments, a method includes obtaining a plurality of camera images from the camera based on a target positioned at a plurality of locations relative to the vehicle, wherein the target includes a plurality of dots arranged in rows and columns according to a random spacing, wherein the target further includes a plurality of enlarged dots arranged in an L shaped pattern in relation to a center of the target; estimating, by a processor, at least one of intrinsic parameters and extrinsic parameters based on the plurality of camera images; and storing, by a processor and in a data storage device, the at least one of intrinsic parameters and extrinsic parameters as calibration parameters associated with the camera.

### TECHNICAL FIELD

The technical field generally relates to cameras and, more specifically, to methods and systems for calibrating cameras for vehicles.

Many vehicles include cameras, including cross traffic cameras for detecting objects in proximity to the vehicle. Each camera, when installed to the vehicle requires calibration of certain intrinsic and extrinsic parameters. For example, intrinsic parameters include the optical center and focal length of the camera. In another example, extrinsic parameters include the location and orientation of the camera in a three-dimensional space and relative to the vehicle. Proper calibration of these parameters allows for more accurate conversion of data captured by the camera into a real-world coordinate system. Providing a more accurate real-world coordinate data allows for improved control of the vehicle.

Accordingly, it is desirable to provide improved methods and systems for calibrating cameras for use in a vehicle. Furthermore, other desirable features and characteristics of the present invention will become apparent from the subsequent detailed description of the invention and the appended claims, taken in conjunction with the accompanying drawings and this background of the invention.

### SUMMARY

In various embodiments, methods and systems for calibrating a camera of a vehicle are provided. In one embodiment, a method includes: obtaining a plurality of camera images from the camera based on a target positioned at a plurality of locations relative to the vehicle, wherein the target includes a plurality of dots arranged in rows and columns according to a random spacing, wherein the target further includes a plurality of enlarged dots arranged in an L shaped pattern in relation to a center of the target; estimating, by a processor, at least one of intrinsic parameters and extrinsic parameters based on the plurality of camera images; and storing, by a processor and in a data storage device, the at least one of intrinsic parameters and extrinsic parameters as calibration parameters associated with the camera.

In various embodiments, the plurality of enlarged dots includes three enlarged dots.

In various embodiments, at least one of the three enlarged dots is a hollow dot.

In various embodiments, the hollow dot is arranged horizontally next to at least one other dot of the three enlarged dots.

In various embodiments, the plurality of dots are spaced based on a temperature of the target.

In various embodiments, the plurality of locations consists of a location associated with a center view of the camera, a location associated with a far-right view of the camera, and a location associated with a far-left view of the camera.

In various embodiments, the method further includes estimating the at least one of intrinsic parameters and extrinsic parameters is based on an initial value and a global minimum, wherein the initial value is associated with an average of a parameter from a plurality of other cameras.

In various embodiments, the method further includes processing the plurality of camera images with a three-dimensional processing tool to determine a plurality of reference points associated with the plurality of dots, and wherein the estimating the at least one of intrinsic parameters and extrinsic parameters is based on the plurality of reference points.

In various embodiments, the intrinsic parameters include distortion parameters. The method further includes estimating the distortion parameters based on a piece-wise linear distortion model.

In another embodiment, a non-transitory computer readable medium is provided. The non-transitory computer readable medium includes an image module configured to obtain a plurality of camera images from a camera based on a target positioned at a plurality of locations relative to the camera, wherein the target includes a plurality of dots arranged in rows and columns according to a random spacing, wherein the target further includes a plurality of enlarged dots arranged in an L shaped pattern in relation to a center of the target; a processing module configured to estimate, by a processor, at least one of intrinsic parameters and extrinsic parameters parameters based on the camera images; and a data storage device configured to store the at least one of intrinsic parameters and extrinsic parameters as calibration parameters associated with the camera.

In various embodiments, the plurality of enlarged dots includes three enlarged dots.

In various embodiments, one of the three enlarged dots is a hollow dot.

In various embodiments, the hollow dot is arranged horizontally next to at least one other dot of the three enlarged dots.

In various embodiments, each of the plurality of dots are spaced based on a temperature of the target.

In various embodiments, the plurality of locations consists of a location associated with a center view of the camera, a location associated with a far-right view of the camera, and a location associated with a far-left view of the camera.

In various embodiments, the processing module is further configured to estimate the at least one of the intrinsic parameters and the extrinsic parameters based on an initial value and a global minimum, wherein the initial value is associated with an average of a parameter from a plurality of other cameras.

In various embodiments, the processing module is further configured to process the plurality of camera images with a three-dimensional processing tool to determine a plurality of reference points associated with the plurality of dots, and estimate the at least one of intrinsic parameters and extrinsic parameters based on the plurality of reference points.

In various embodiments, the intrinsic parameters include distortion parameters. The processing module is further configured to estimate the distortion parameters based on a piece-wise linear distortion model.

In another embodiment, a calibration system for a vehicle is provided. The calibration system includes a target including a plurality of dots arranged in rows and columns according to a random spacing, wherein the target further includes a plurality of enlarged dots arranged in an L shaped pattern in relation to a center of the target; a camera disposed onboard a vehicle and configured to generate a plurality of camera images of the target; a processor configured to receive the plurality of camera images and estimate at least one of intrinsic parameters and extrinsic parameters based on the camera images; and a data storage device configured to store the at least one of intrinsic parameters and extrinsic parameters as calibration parameters associated with the camera.

In various embodiments, the processor is configured to estimate the at least one of intrinsic parameters and extrinsic parameters based on an initial value and a global minimum, wherein the initial value is associated with an average of a parameter from a plurality of other cameras, wherein the processor is configured to estimate distortion parameters of the intrinsic parameters based on a piecewise linear distortion model.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes cameras and a control system for calibrating the cameras, in accordance with various embodiments;

FIG. 2 is a dataflow diagram illustrating the control system of FIG. 1, in accordance with various embodiments;

FIG. 3 is an illustration of a target used to capture camera images by the control system of FIG. 1, in accordance with various embodiments;

FIG. 4 is an illustration of target placement, in accordance with various embodiments;

FIG. 5 is a flowchart of a process for calibrating vehicle cameras, that can be implemented in connection with the vehicle, the cameras, the control system, and the target of FIGS. 1, 2 and 3, in accordance with various embodiments;

FIGS. 6A and 6B illustrate exemplary camera images obtained from locations of the target relative to the camera;

FIG. 7 is a graph illustrating values for refining calibration parameters in accordance with various embodiments; and

FIG. 8 is an illustration of steps of a method for determining distortion parameters, in accordance with various embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

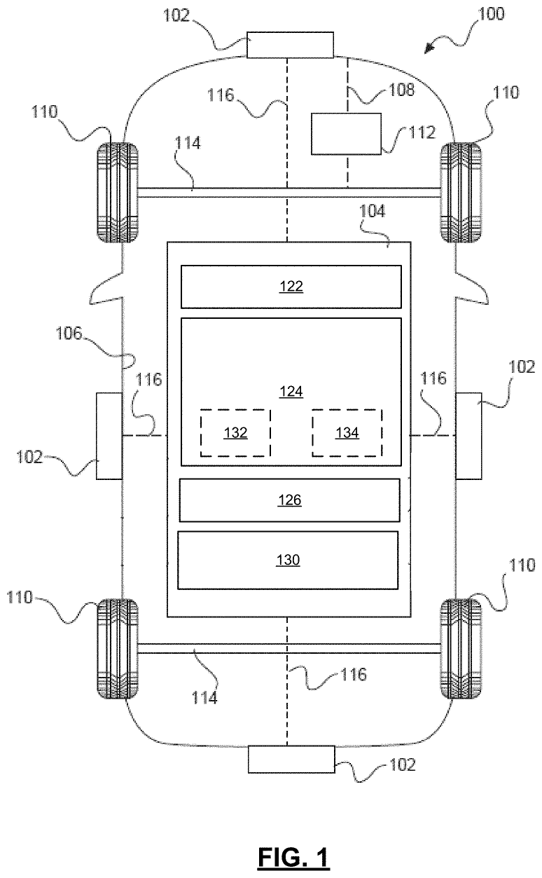

FIG. 1 illustrates a vehicle 100, according to an exemplary embodiment. As described in greater detail further below, the vehicle 100 includes cameras 102 and a control system 104. In certain embodiments, the cameras 102 are controlled via a control system 104, as depicted in FIG. 1. The control system 104 calibrates the cameras 102 for use in projecting the camera images onto a three-dimensional space.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, and/or one or more other types of mobile platforms (e.g., a robot, a ship, and so on) and/or other systems, for example having a camera image with a fixed referenced point.

The vehicle 100 includes a body 106 that is arranged on a chassis 108. The body 106 substantially encloses other components of the vehicle 100. The body 106 and the chassis 108 may jointly form a frame. The vehicle 100 also includes a plurality of wheels 110. The wheels 110 are each rotationally coupled to the chassis 108 near a respective corner of the body 106 to facilitate movement of the vehicle 100. In one embodiment, the vehicle 100 includes four wheels 110, although this may vary in other embodiments (for example for trucks and certain other vehicles).

A drive system 112 is mounted on the chassis 108, and drives the wheels 110, for example via axles 114. The drive system 112 preferably comprises a propulsion system. In certain exemplary embodiments, the drive system 112 comprises an internal combustion engine and/or an electric motor/generator, coupled with a transmission thereof. In certain embodiments, the drive system 112 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, in certain embodiments, the cameras 102 include a rear vision camera that is mounted on a rear portion of the vehicle 100, a front vision camera that is mounted on a front portion of the vehicle 100, a driver side camera that is mounted on a driver side of the vehicle 100, and a passenger side camera that is mounted on a passenger side of the vehicle 100. In various embodiments, the cameras 102 capture images of the vehicle 100 and/or the surrounding environment of the vehicle 100, for example in detecting other vehicles, other objects, a roadway, roadway features, and the like from various sides of the vehicle 100 (e.g., front side, rear side, passenger side, and driver side), for example to assist the vehicle 100 in travelling along a roadway (e.g., to avoid contact with other vehicles and/or other objects). In various embodiments, one or more of the cameras 102 may also be disposed on one or more other locations of the vehicle 100, for example on top of the vehicle 100 or inside of the vehicle 100, for example to create a surround view and/or one or more other views for the vehicle 100. In various embodiments, the number, locations, and/or placement of the cameras 102 may vary (e.g., in certain embodiments, a single camera may be used, and so on).

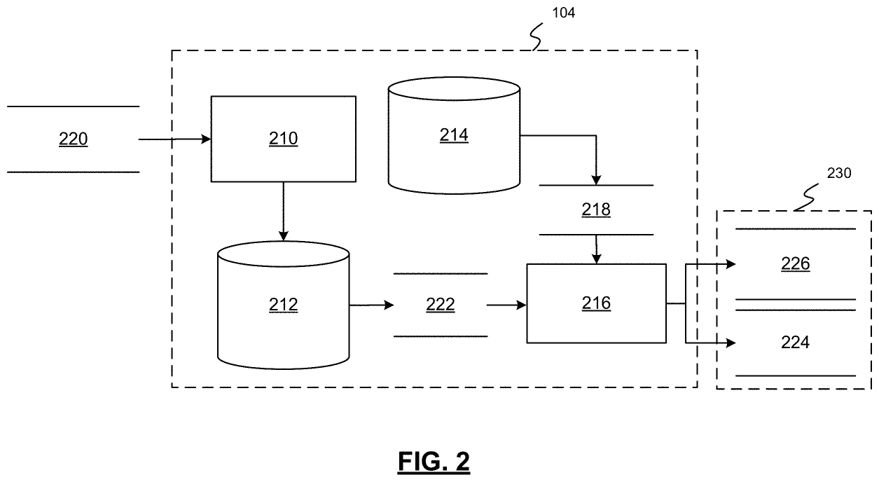

In various embodiments, the control system 104 controls operation of the cameras 102, and calibrates the cameras 102, for example for use in projecting camera images onto a three-dimensional space. In various embodiments, the control system 104 provides these and other functions in accordance with the embodiments discussed with regard to FIGS. 2-7.

In various embodiments, the control system 104 is disposed within the body 106 of the vehicle 100. In certain embodiments, the control system 104 and/or one or more components thereof may be disposed outside of the body 106, for example on a partially or fully on a remote server, in the cloud, or in a remote smart phone or other device where image processing can be performed remotely. In addition, in various embodiments, the control system 104 may be disposed within and/or as part of the cameras 102 and/or within and/or or as part of one or more other vehicle systems (not shown).

Also, as depicted in FIG. 1, in various embodiments the control system 104 is coupled to the cameras 102 via one or more communications links 116 and receives camera images from the cameras 102 via the communications links 116. In certain embodiments, each communications link 116 comprises one or more wired connections, such as one or more cables (e.g. coaxial cables and/or one or more other types of cables). In other embodiments, each communications link 116 may comprise one or more wireless connections, e.g., using one or more transceivers.

In various embodiments, the control system 104 comprises a computer system. For example, the control system 104 includes a processor 122, a memory 124, an interface 126, and a bus 130. The processor 122 performs the computation and control functions of the computer system and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 stored within the memory 124 and, as such, controls the general operation of the computer system. In various embodiments, the processor executes programs 132 described with regard to the systems and processes described further below in connection with FIG. 2-7.

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on a same computer chip as the processor 122. In the depicted embodiment, the memory 124 stores the above-referenced program 132 along with one or more stored values 134 (e.g., including, in various embodiments, previous calibrations, default calibrations, etc.).

The interface 126 allows communication to the computer system, for example from a system driver and/or another computer system and can be implemented using any suitable method and apparatus. In one embodiment, the interface 126 obtains the various data from the cameras 102. The interface 126 can include one or more network interfaces to communicate with other systems or components. The interface 126 may also include one or more network interfaces to communicate with technicians, and/or one or more storage interfaces to connect to storage apparatuses.

The bus 130 serves to transmit programs, data, status and other information or signals between the various components of the computer system. The bus 130 can be any suitable physical or logical means of connecting computer systems and components. This includes, but is not limited to, direct hard-wired connections, fiber optics, infrared and wireless bus technologies.

It will be appreciated that while this exemplary embodiment is described in the context of a fully functioning computer system, those skilled in the art will recognize that the mechanisms of the present disclosure are capable of being distributed as a program product with one or more types of non-transitory computer-readable media used to store the program and the instructions thereof and carry out the distribution thereof, such as a non-transitory computer readable medium bearing the program and containing computer instructions stored therein for causing a computer processor (such as the processor 122) to perform and execute the program. It will similarly be appreciated that the computer system may also otherwise differ from the embodiment depicted in FIG. 1.

With reference now to FIG. 2 and with continued reference to FIG. 1, a dataflow diagram illustrates the control system 104 of FIG. 1 being configured to calibrate the cameras 102 in accordance with exemplary embodiments. As depicted in FIG. 2, in various embodiments, the control system 104 can includes one or more modules. As can be appreciated, the modules shown may be combined and/or further partitioned to calibrate one or more of the cameras 102 of the vehicle 100. In various embodiments, the control system 104 includes an image module 210, an image datastore 212, a model datastore 214, and a processing module 216.

The model datastore 214 stores model data 218 relating to one or more targets defined for use in the calibration process. The model data 28 includes N reference points, X₀, . . . , X_{N-1}. Each reference point corresponds to a feature of a defined target.

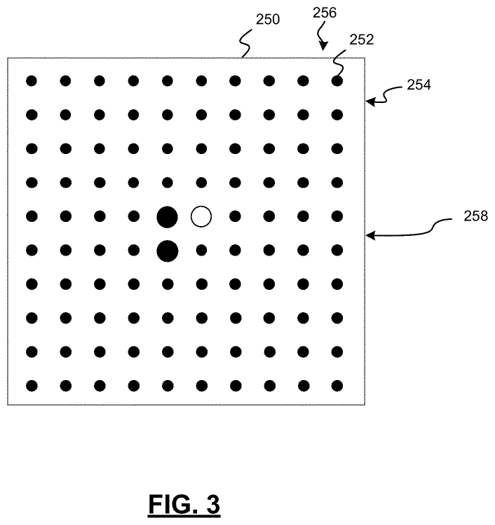

For example, in various embodiments, the target is a planer surface having illustrated features. The illustrated features are captured by the camera 102 in a camera image 220. As shown in an exemplary embodiment of FIG. 3, a target 250 can include features such as a plurality of “dots” 252 or enclosed circles. As can be appreciated, other shapes can be used as features in various embodiments. As shown, the dots 252 are arranged in rows and columns. FIG. 3 illustrates ten rows and ten columns. As can be appreciated any number of rows and any number of columns can be implemented in various embodiments.

In various embodiments, the vertical spacing 254 and/or the horizontal spacing 256 between the dots 252 in the target 250 are defined to have a random variation. For example, when defining the target 250, the horizontal distance between a dot in column 10 and a dot in column 9 (distᵢ) is set to a defined distance plus a random value (a). In another example, when defining the target 250, the vertical distance between a dot in column 1 and a dot in column 2 (distⱼ) is set to a defined distance plus a random value (a).

In various embodiments, the spacing 254, 256 between the dots 252 in the target 250 can be varied based on a temperature of the target. For example, the dot locations L are compensated for temperature variation (T) of the target with known thermal expansion coefficients (TEC) as L=l+1 ΔT*TEC.

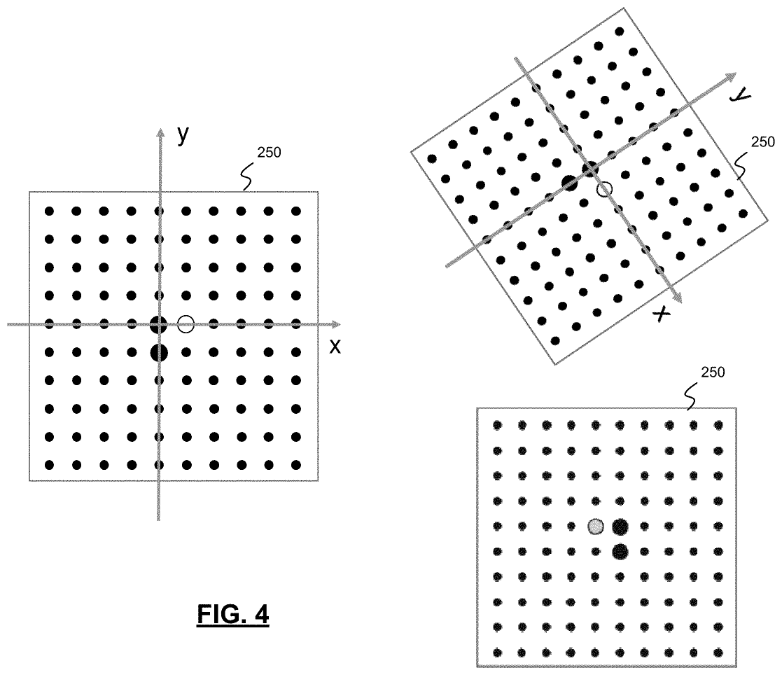

In various embodiments, the target 250 further includes markers 258 shown as enlarged dots (dots greater in size than the other dots), that distinguish over the other dots. The markers 258 are located at or near a center of the target 250. As shown, the markers 258 may include two enlarged dots and one enlarged but hollow dot. The markers 258 are arranged in an L shape, with the two enlarged dots are vertically adjacent, and the one enlarged, hollow data is horizontally adjacent to one of the enlarged dots. As shown in FIG. 4, the arrangement of the markers 258 aids in the determination of orientation parameters of the camera 102 and the detection of mirrored camera images when the target the location and orientation of the target 250 is varied.

With reference back to FIG. 2, in various embodiments, the image module 210 obtains camera images 220 of a selected target taken by a camera 102. For example, a target such as the target 250 described with respect to FIG. 3 is selected and is placed at a number of different locations and/or orientations relative to the camera 102 (or the camera 102 is placed relative to the target 250), and the camera 102 captures a camera image 220 of the target 250 at each of these locations/orientations and provides the camera image 220 to the image module 210. For example, the target 250 may be placed at a first location straight in front of the camera 102 and a first camera image 220 is produced. The target 250 may then be moved to a second location at a far-left view of the camera 220 and a second camera image 220 is produced. The target may then be moved to a third location at a far-right view of the camera 102 and a third camera image 220 is produced. As can be appreciated, any number of camera images 220 can be captured of the target 250 (or other target) placed at any number of locations and according to any number of orientations in various embodiments.

The image module 210 receives the captured images 220 and stores the captured images in the image datastore 212 for future processing.

The processing module 220 retrieves stored camera images 222 and processes the camera images 222. The processing module 220 retrieves model data 218 corresponding to the target 250 used to produce the camera images 222. The processing module processes the camera images 222 and the model data 218 and provides calibration parameters 230 for use in calibrating the camera 102.

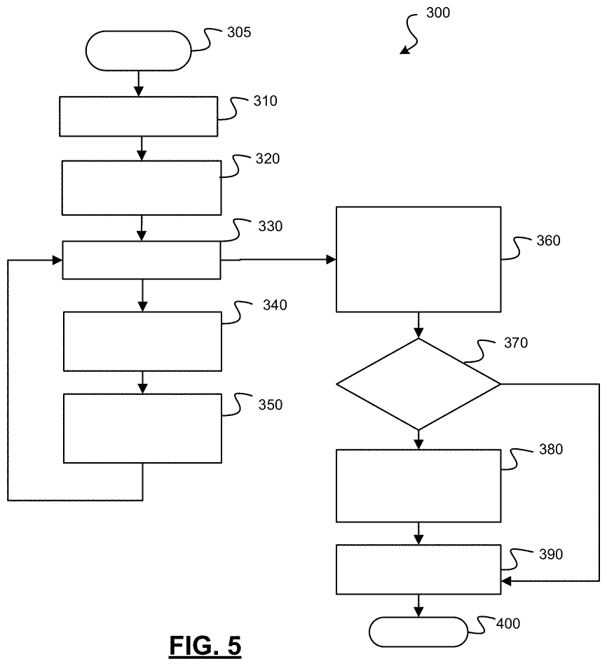

For example, as shown in more detail with regard to FIGS. 5, 6A, 6B, 7, and 8, in various embodiments, the processing module 220 processes the images according to one or more processing methods. FIG. 5, for example, is a flowchart of a process 300 for processing the camera images 222, in accordance with exemplary embodiments. The process 300 can be implemented in connection with the vehicle 100, cameras 102 and control system 104 of FIGS. 1 and 2, in accordance with exemplary embodiments. As can be appreciated, the order of the method may vary, and/or one or more steps may be added or removed in various embodiments.

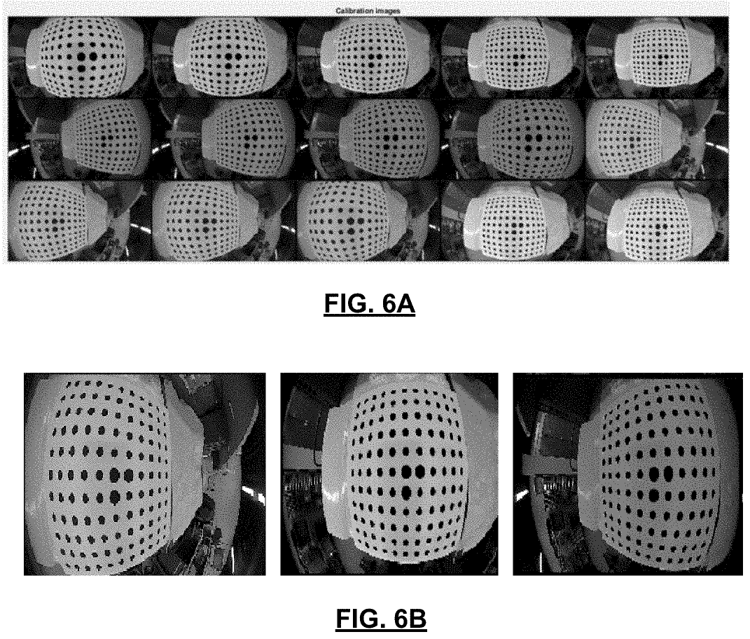

As depicted in FIG. 5, the process may begin at 305. Camera images 222 (I₀, . . . Iₘ₋₁) (e.g., that are obtained under different views by the camera 102 by moving the target 250 and/or the camera 102) at 310. In various embodiments, as shown in FIG. 6A, fifteen or any other number of camera images are obtained. In various embodiments, as shown in FIG. 6B, three camera images are obtained, one from a center view, one from a far-right view, and one from a far-left view. While any number of images may be used, estimating the camera calibrations based on a minimal number of camera images 222 and using an initial guess for the parameters improves performance of the processing and simplifies the overall vehicle manufacturing and calibration process.

Thereafter, the model data 218 relating to the type of target used to capture the images is retrieved from the model datastore 214 at 320.

Each camera image 222 is processed based on the model data 218 at 330-350. For example, features (e.g., dots) are identified in each camera image 222 and data (reference points) relating to the dots is extracted at 340. For example, the center locations identified by the marker can be identified with a precision three-dimensional tool. From the extracted data, a linear mapping is performed between the extracted data and the model data 218 at 350.

Once all the camera images 222 have been processed for their linear mappings at 330, the intrinsic parameters 224 (including distortion values) and the extrinsic parameters 226 are estimated using an initial guess and a non-linear optimization technique at 360.

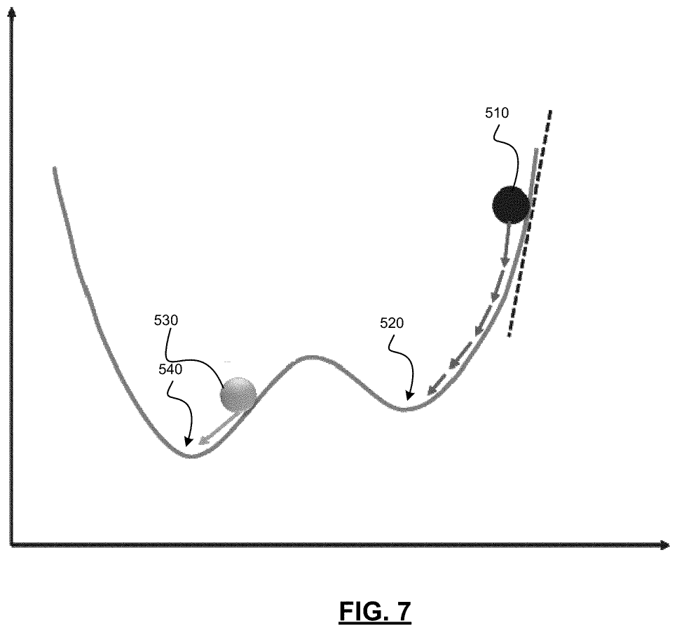

For example, when fifteen or more camera images 222 are used (e.g., as shown in FIG. 6A), the intrinsic parameters—f (focal length), c (image center), d (diagonal distortion) and the extrinsic parameters—R (rotation matrix), T (translation vector) are refined based on initial values 510 (FIG. 7) that are estimated, for example, from linear optimization techniques, and further based on a non-linear optimization techniques that identify a local minimum 620 (FIG. 7):

min ΣⱼΣᵢ|xij−f(Xij,f,c,d(.)R,T)|.

In another example, when the minimal number (e.g., three as shown in FIG. 6B) of camera images 222 are used, the intrinsic parameters—f (focal length), c (image center), d (diagonal distortion) and the extrinsic parameters—R (rotation matrix), T (translation vector) are refined based on an initial guess 530 (FIG. 7) that is an average of known parameters from similar cameras, and further based on a non-linear optimization technique that identifies a global minimum 540 (FIG. 7):

min ΣⱼΣᵢ|xij−f(Xij,f,c,d(.)R,T)|.

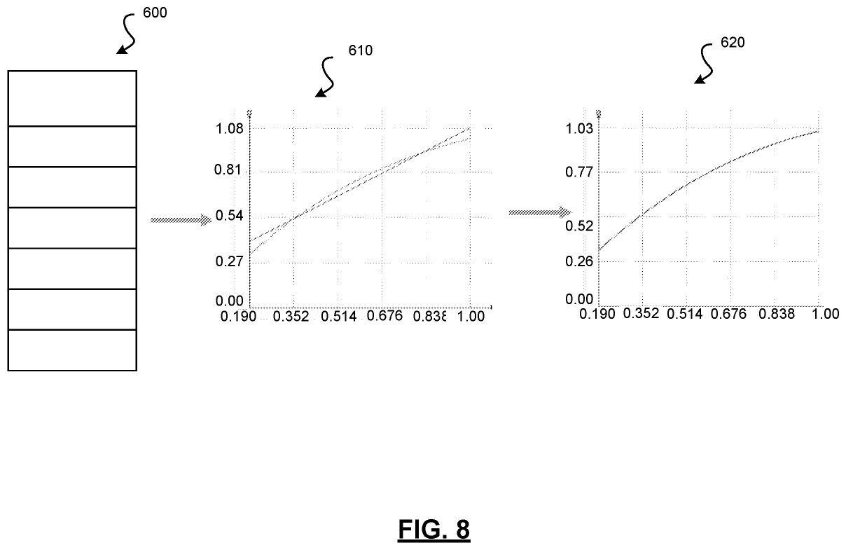

In various embodiments, the estimated distortion parameters may be improved. For example, when the distortion parameters are inadequate (the error is greater than a threshold) at 370, the distortion parameters are estimated using measured distortion values from the pixels and a piecewise linear distortion model at 380. For example, as shown in FIG. 8, the camera image is processed, and distortion values are estimated per pixel using general models (e.g., θ, tan(θ), cos(θ), sin(θ), tan²(θ), cos²(θ)) at 600. A best fit is then selected from the general models at 610. Thereafter, a piecewise linear improvement is performed on the selected model to improve the values at 620.

With reference back to FIG. 5, once the estimated parameters are determined to be adequate, the estimated parameters including the intrinsic parameters 224 and the extrinsic parameters 226 are made available to the vehicle 110 as camera calibrations 230 at 390. The camera calibrations 230 are then used in image data processing and controlling the vehicle 100. Thereafter, the method may end at 400.

Accordingly, methods, systems, and vehicles are provided for calibrating cameras for vehicles. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of calibrating a camera of a vehicle, comprising:
obtaining a plurality of camera images from the camera based on a target positioned at a plurality of locations relative to the vehicle, wherein the target includes a plurality of dots arranged in rows and columns according to a random spacing, wherein the target further includes a plurality of enlarged dots arranged in an L shaped pattern in relation to a center of the target;
estimating, by a processor, at least one of intrinsic parameters and extrinsic parameters based on the plurality of camera images; and
storing, by a processor and in a data storage device, the at least one of intrinsic parameters and extrinsic parameters as calibration parameters associated with the camera.

2. The method of claim 1, wherein the plurality of enlarged dots includes three enlarged dots.

3. The method of claim 2, wherein at least one of the three enlarged dots is a hollow dot.

4. The method of claim 3, wherein the hollow dot is arranged horizontally next to at least one other dot of the three enlarged dots.

5. The method of claim 1, wherein the plurality of dots are spaced based on a temperature of the target.

6. The method of claim 1, wherein the plurality of locations consists of a location associated with a center view of the camera, a location associated with a far-right view of the camera, and a location associated with a far-left view of the camera.

7. The method of claim 6, further comprising refining the calibration parameters based on an initial value and a global minimum, wherein the initial value is associated with an average of a parameter from a plurality of other cameras.

8. The method of claim 1, further comprising processing the plurality of camera images with a three-dimensional processing tool to determine a plurality of reference points associated with the plurality of dots, and wherein the estimating the at least one of intrinsic parameters and extrinsic parameters is based on the plurality of reference points.

9. The method of claim 1, wherein the intrinsic parameters include distortion parameters and wherein the method further comprises estimating the distortion parameters based on a piece-wise linear distortion model.

10. A non-transitory computer readable medium for calibrating a camera, comprising:
an image module configured to obtain a plurality of camera images from a camera based on a target positioned at a plurality of locations relative to the camera, wherein the target includes a plurality of dots arranged in rows and columns according to a random spacing, wherein the target further includes a plurality of enlarged dots arranged in an L shaped pattern in relation to a center of the target;
a processing module configured to estimate, by a processor, at least one of intrinsic parameters and extrinsic parameters based on the camera images; and
a data storage device configured to store the at least one of intrinsic parameters and extrinsic parameters as calibration parameters associated with the camera.

11. The non-transitory computer readable medium of claim 10, wherein the plurality of enlarged dots includes three enlarged dots.

12. The non-transitory computer readable medium of claim 11, wherein one of the three enlarged dots is a hollow dot.

13. The non-transitory computer readable medium of claim 12, wherein the hollow dot is arranged horizontally next to at least one other dot of the three enlarged dots.

14. The non-transitory computer readable medium of claim 10, wherein the each of the plurality of dots are spaced based on a temperature of the target.

15. The non-transitory computer readable medium of claim 10, wherein the plurality of locations consists of a location associated with a center view of the camera, a location associated with a far-right view of the camera, and a location associated with a far-left view of the camera.

16. The non-transitory computer readable medium of claim 15, wherein the processing module is configured to estimate the at least one of intrinsic parameters and the extrinsic parameters based on an initial value and a global minimum, wherein the initial value is associated with an average of a parameter from a plurality of other cameras.

17. The non-transitory computer readable medium of claim 10, wherein the processing module is further configured to process the plurality of camera images with a three-dimensional processing tool to determine a plurality of reference points associated with the plurality of dots, and estimate the at least one of intrinsic parameters and the extrinsic parameters based on the plurality of reference points.

18. The non-transitory computer readable medium of claim 10, wherein the intrinsic parameters include distortion parameters and wherein the processing module is further configured to estimate the distortion parameters based on a piece-wise linear distortion model.

19. A calibration system for a vehicle, comprising:
a target including a plurality of dots arranged in rows and columns according to a random spacing, wherein the target further includes a plurality of enlarged dots arranged in an L shaped pattern in relation to a center of the target;
a camera disposed onboard a vehicle and configured to generate a plurality of camera images of the target;
a processor configured to receive the plurality of camera images and estimate at least one of intrinsic parameters and extrinsic parameters based on the camera images; and
a data storage device configured to store the at least one of intrinsic parameters and extrinsic parameters as calibration parameters associated with the camera.

20. The calibration system of claim 19, wherein the processor is configured to estimate the at least one of intrinsic parameters and extrinsic parameters based on an initial value and a global minimum, wherein the initial value is associated with an average of a parameter from a plurality of other cameras, wherein the processor is configured to estimate distortion parameters of the intrinsic parameters based on a piecewise linear distortion model.
